(19) United States
(12) Patent Application Publication
(10) Pub. No.: US 2013/0127708 A1
(43) Pub. Date: May 23, 2013

(54) CELL-PHONE BASED WIRELESS AND MOBILE BRAIN-MACHINE INTERFACE

(71) Applicants: Tzyy-Ping Jung, San Diego, CA (US); Yi-Jun Wang, San Diego, CA (US); Yu-Te Wang, San Diego, CA (US)

(72) Inventors: Tzyy-Ping Jung, San Diego, CA (US); Yi-Jun Wang, San Diego, CA (US); Yu-Te Wang, San Diego, CA (US)

(73) Assignee: THE REGENTS OF THE UNIVERSITY OF CALIFORNIA, Oakland, CA (US)

(21) Appl. No.: 13/700,728

(22) PCT Filed: May 27, 2011
(86) PCT No.: PCT/US11/38458

§ 371 Date: Dec. 18, 2012

Related U.S. Application Data
(60) Provisional application No. 61/349,799, filed on May 28, 2010.

(51) Int. Cl. G06F 3/01

(52) U.S. Cl. CPC G06F 3/015
USPC 345/156

(57) ABSTRACT

Techniques and systems are disclosed for implementing a brain-computer interface. In one aspect, a system for implementing a brain-computer interface includes a stimulator to provide at least one stimulus to a user to elicit at least one electroencephalogram (EEG) signal from the user. An EEG acquisition unit is in communication with the user to receive and record the at least one EEG signal elicited from the user. Additionally, a data processing unit is in wireless communication with the EEG acquisition unit to receive and process the recorded at least one EEG signal to perform at least one of: sending a feedback signal to the user, or executing an operation on the data processing unit.

### CROSS-REFERENCE TO RELATED APPLICATIONS

This patent application claims priority of U.S. Provisional Patent Application No. 61/349,799, filed May 28, 2010, entitled “A CELL-PHONE BASED WIRELESS AND MOBILE BRAIN-MACHINE INTERFACE”, the entire disclosure of which is incorporated by reference as a part of this application.

### BACKGROUND

This application relates to devices and techniques that use electroencephalogram (EEG) technologies.

Various brain-machine interfaces are applicable to different applications. For example, Emotive and Matel/Neurosky are brain-machine interfaces used in gaming. My zeo is an EEG based sleep stager. These brain-computer interfaces require either a proprietary data logger or a processor to perform online EEG analysis. Moreover, existing EEG systems are bulky and tethered systems not meant for providing portability. In addition, the electrodes used in these systems require complex and manual setup procedures.

### SUMMARY

Techniques and systems and apparatus are disclosed for implementing a mobile and wireless brain-computer interface (BCI) based on customized Electroencephalogram (EEG).

In one aspect, a system for implementing a brain-computer interface includes a stimulator to provide at least one stimulus to a user to elicit at least one electroencephalogram (EEG) signal from the user. An EEG acquisition unit is in communication with the user to receive and record the at least one EEG signal elicited from the user. Additionally, a data processing unit is in wireless communication with the EEG acquisition unit to receive and process the recorded at least one EEG signal to perform at least one of: sending a feedback signal to the user, or executing an operation on the data processing unit.

Implementations can optionally include one or more of the following features. The EEG acquisition unit can include an electrode in communication with the user to receive the EEG signal. The EEG acquisition unit can include analog circuitry to amplify and filter the received EEG signal. The analog circuitry can include instrument amplifiers to amplify the received EEG signal. Also, the analog circuitry can include a filter to band-pass filter the amplified EEG signal. Also, the EEG acquisition unit can include digital circuitry to generate a digital EEG signal based on the amplified and filtered EEG signal. The digital circuitry can include an analog-to-digital converter to generate a digital EEG signal based on the amplified and filtered EEG signal; and a microcontroller in communication with the analog-to-digital converter to control generation of the digital EEG signal. The data processing device can be configured to: receive the digital EEG signals from the EEG acquisition unit; process the received digital EEG signal; and responsive to processing the received digital EEG signal, perform the at least one of sending a feedback signal to the user or executing a function on the data processing device. The data processing device can include a mobile cellular phone. The stimulator can include a visual stimulator to provide at least one visual stimulus to the user. The visual simulator can include a monitor with a stimulus matrix. The system can include a stimulus program for causing the stimulus unit to applying the at least one stimulus to the user. The stimulus program can be configured to vary frequencies of the applied at least one stimulus. The EEG acquisition unit can further include a communication transceiver to transmit the digitized EEG signal to the data processing device. The communication transceiver can include a Bluetooth or radio-frequency transmitter. The data processing device can include a communication transceiver to receive the transmitted digital EEG signal. The data processing device can be configured to execute the operation on the data processing unit comprising making a telephone call.

In another aspect, a method of implementing a brain-computer interface includes initiating a connection between a data processing device and an EEG acquisition unit. Responsive to a successful connection, multi-channel raw EEG data is received, filtered, and the filtered EEG data is plotted on a screen of the data processing device periodically.

Implementations can optionally include one or more of the following features. Responsive to a user input, a display mode of the plotted EEG data can be switched between a time-domain display mode and a frequency-domain display mode. The scale of the plotted data can be adjusted. A time-domain analysis (e.g. temporal waveform detection, template matching using cross-correlation, phase coherent detection, inter-trace correlation, canonical correlation analysis (CCA), Minimal energy combination, lock-in analyzer system) or frequency-domain signal-processing (e.g. Fast Fourier Transform, wavelet transform, etc) algorithm can be applied to the filtered EEG data. A target can be detected responsive to detecting the same dominant frequency in two consecutive windows.

In yet another aspect, a computer-program product can be tangibly embodied on a non-transitory storage medium, and configured to cause a data processing device to perform operations of the methods described above.

The subject matter described in this specification potentially can provide one or more of the following advantages. For example, the described mobile and wireless BCI based on customized Electroencephalogram (EEG) recording and signal processing modules can have the advantage of ultimate portability, wearability and usability. Also, the described techniques, apparatus and systems can be used to implement noninvasive EEG systems that are capable of high-definition recording, online signal processing, and artifact cancellation. The described techniques, systems and apparatus can integrate a mobile and wireless EEG system and a signal-process platform based on a ubiquitous mobile device (e.g., a cell phone) into a truly wearable BCI. Additionally, the mobile device based EEG acquisition and online processing systems can remove the needs of the users to carry a special-purpose EEG processor to analyze the signals. Implications in clinical research and practice are numerous since it will make possible the ubiquitous and wireless physiological (not limited to EEG) signal monitoring from any time, any place and anywhere. For example, a cell phone can be programmed to assess steady-state visual-evoked potentials (SSVEP) in response to flickering visual stimuli to make a phone call directly. The results of this study on ten normal subjects suggested that the proposed mobile and wireless BCI system can be used to implement EEG monitoring and on-line processing of unconstrained subjects in real-world environments. Moreover, the described BCI systems can be applied to single- or multi-player Gaming on cell phones and biomedical information monitoring in neurology, psychiatry, gerontology, and rehabilitation medicine, and other applications.

### BRIEF DESCRIPTION OF THE DRAWINGS

FIG. 1 shows a basic hardware scheme of a mobile and wireless BCI system.

FIG. 2A shows a block diagram of the EEG acquisition unit.

FIG. 2B shows an EEG headband with an embedded data acquisition and wireless telemetry unit.

FIG. 3 is a table showing example specifications of an EEG acquisition unit.

FIGS. 4A and 4B show screen snapshots of the cell-phone's GUI: (A) A time-domain display of the 4-channel EEG, and (B) Estimated power spectral density using Fast Fourier Transform (FFT) of the EEG when number ‘1’ is attended.

FIG. 5 shows a flow chart of software program coded on the data processing device, such as a cell phone.

FIG. 6 is a table showing the results of the EEG-based phone-dialing experiments.

FIG. 7 is a block diagram representation of a BCI system.

FIG. 8 is a table showing test results for certain embodiments.

FIG. 9 is a block diagram representation of a BCI system.

FIG. 10 is a block diagram representation of a dry electrode embodiment.

FIG. 11 is a block diagram representation of a non-contact electrode embodiment.

FIG. 12 is a graphical representation of signals recorded in a non-contact electrode embodiment.

FIG. 13 is a graphical representation of signals recorded in various electrode embodiments.

FIG. 14 is a graphical representation of SSVEP signals generated in various BCI system embodiments.

FIG. 15 is a tabular representation comparing results obtained for certain wet and dry electrode embodiments.

FIG. 16 is a graphical representation of spectrograms of certain signals generated in various BCI systems.

FIG. 17 is a tabular representation comparing results obtained for certain wet and dry electrode embodiments.

FIG. 18 is a graphical representation of power spectral densities of certain signals generated in a BCI system.

Like reference symbols and designations in the various drawings indicate like elements.

### DETAILED DESCRIPTION

The techniques, apparatus and systems described in this application can be used to implement a brain-computer interface (BCI) which features wearable and wireless electroencephalogram (EEG) acquisition and software on a mobile device, such as a cell-phone to provide a platform for BCI applications in real-world environments. Implications of BCI can be demonstrated using sample applications, such as dialing a phone number with noninvasive EEG.

BCI systems can acquire EEG signals from the human brain and translate them into digital commands which can be recognized and processed on a computer or computers using advanced algorithms. BCIs can provide a new interface for the users who are suffering from motor disabilities to control assistive devices such as wheelchairs. Over the past two decades, different features of EEG signals such as mu/beta rhythms, event-related P300 potentials, and visual evoked potentials (VEP) have been used in BCI studies. Among these different BCI regimes, the VEP-based BCI can provide high information transfer rate (ITR), little user training, low user variation, and ease of use.

Steady-state visual evoked potential (SSVEP) may refer to the electrical response of the brain to the flickering visual stimulus at a repetition rate higher than 6 Hz. The SSVEP may be characterized by an increase in amplitude at the stimulus frequency, which makes it possible to detect the stimulus frequency based on the measurement of SSVEPs. A frequency coding approach can be used in SSVEP-based BCI systems. In the SSVEP-based BCI systems, each visual target is flickering at a different frequency. The system can recognize the gaze target of the user through detecting the dominant frequency of the SSVEP. While the system performance can be robust for the SSVEP-based BCI systems, moving this type of BCI system from a laboratory demonstration to real-life applications still poses severe challenges. Some of the issues addressed in the present specification for practicability of a BCI system include, e.g., 1) the ease of use, 2) reliable system performance, 3) low-cost hardware and software.

It may be beneficial that in some real-life applications, BCI systems should not use bulky, wired EEG acquisition device and signal processing platform. One reason may be that bulky, wired EEG acquisition device and signal processing platform can be uncomfortable and inconvenient for the users. Also, such bulky and wired BCI systems can affect the users' ability to perform routine tasks in real life. Moreover, signal processing of BCI systems should be performed in real-time rather than off-line.

In one aspect, the described techniques, systems and apparatus can integrate a wearable and wireless EEG system with a mobile phone to implement an SSVEP-based BCI system. For example, the system can include a four-channel biosignal acquisition/amplification module, a wireless transmission module and a Bluetooth-enable cell phone. In one application, the wearers' EEG was used to directly make a phone call. Real-time data processing was implemented and carried out on a regular cell phone. In a normal office environment, an average information transfer rate (ITR) of 28.47 bits/min was obtained from ten healthy subjects.

While the ensuing embodiments are described with reference to a hardware platform such as a mobile cell phone, it will be understood that the disclosed techniques can also be implemented using platforms such as tablet devices (e.g., Android or Windows based tablets). Furthermore, the presentation of visual stimuli and recording and analysis of the response may also be performed on a same device, such as a tablet computer of a mobile phone.

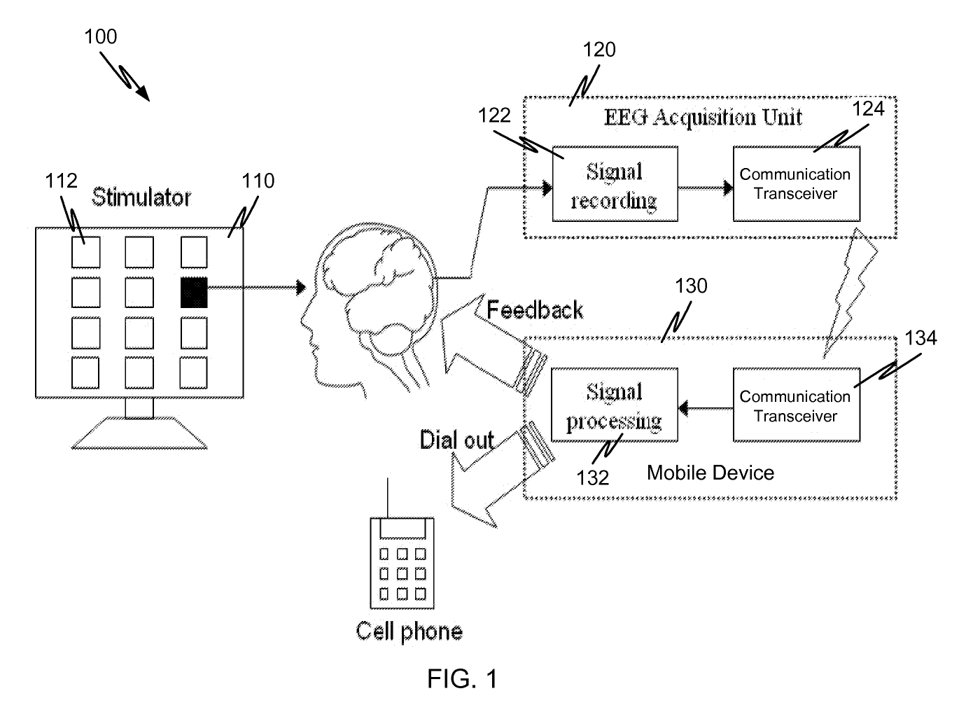

FIG. 1 shows one exemplary embodiment of a mobile and wireless BCI system 100. The hardware of this system can include (or consist mainly of) three major components: a stimulator 110, an EEG acquisition unit 120 and a mobile device (e.g., a mobile cell phone, a tablet, a smart phone, a personal digital assistant, etc.) 130. The stimulator 110 can include multiple individual stimulating units 112, such as electrodes. For example, the stimulator 110 can be implemented as a visual stimulator that includes a monitor (e.g., a 21-inch CRT monitor having a 140 Hz refresh rate, 800×600 screen resolution) with a stimulus matrix (e.g., a 4×3 stimulus matrix) constituting a virtual telephone keypad which includes digits 0-9, BACKSPACE and ENTER. The stimulus frequencies can be varied. For example, the stimulus can range from 9 Hz to 11.75 Hz with an interval of 0.25 Hz between two consecutive digits. The stimulus unit 110 can operate based on a stimulus program. The stimulus program can be developed using various programming languages, such as Microsoft Visual C++ using the Microsoft DirectX 9.0 framework.

The EEG acquisition unit 120 can include a signal recording unit 122 and a communication transceiver 124, such as a Bluetooth transmitter. The mobile device 130 can include a signal processing unit 132 and a communication transceiver, such as a Bluetooth receiver.

The stimulator 110 can initiate a visual stimulation directed at a user, and responsive to the visual stimulation, the EEG acquisition unit 120 receives an EEG signal from the user. The signal recording unit 122 of the EEG acquisition unit 120 records the received EEG signal and forwards the signal to the communication transceiver, such as a Bluetooth transmitter 124 to be transmitted to the mobile device 130. The communication transceiver 134, such as the Bluetooth receiver receives the transmitted EEG signal and forwards it to the signal processing unit 132 to be processed. Based on the processing, a telephone call can be made and/or feedback provided back to the user.

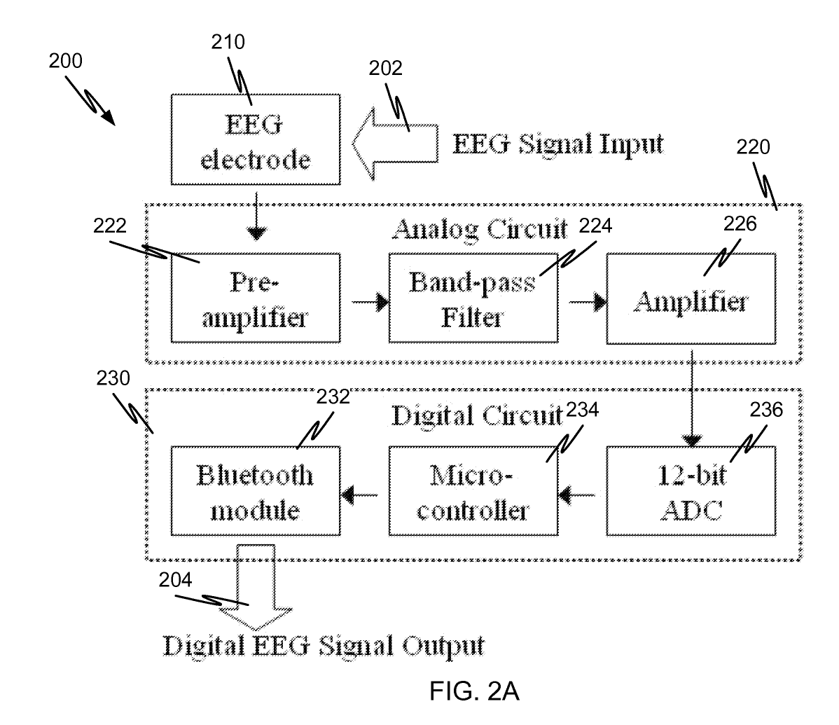

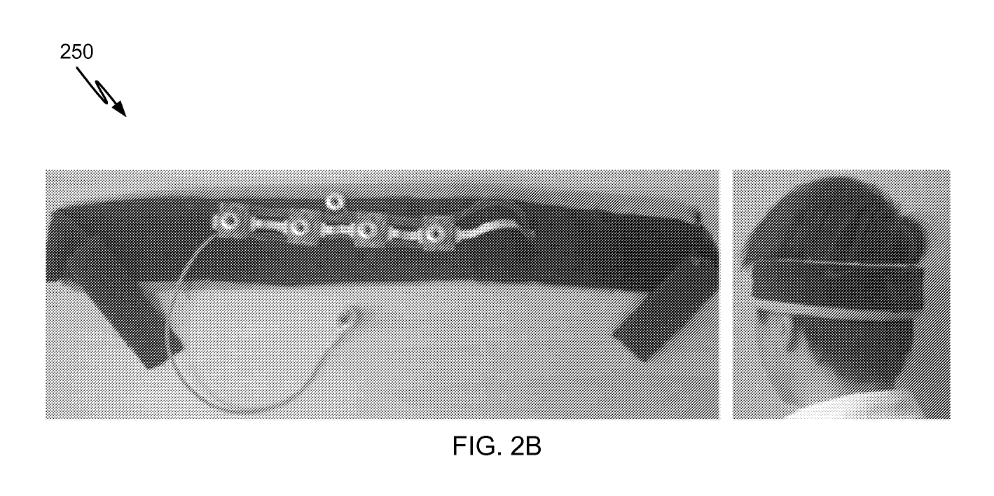

FIG. 2A shows a block diagram of the EEG acquisition unit, and FIG. 2B shows an EEG headband with an embedded data acquisition and wireless telemetry unit. The EEG acquisition unit 120 may be implemented as a multi-channel (e.g., 4-channel) wearable biosignal acquisition unit 200. In FIG. 2A, the data flow of the EEG acquisition unit is also shown. The EEG input signals 202 may be received through an EEG electrode unit 210. The received EEG input signals 202 may be processed by analog circuitry 220. The analog circuitry 220 can include instrument amplifiers, such as a pre-amplifier 222 and an amplifier 226 that amplifies (e.g., 8,000×) the received signal. The amplified signals may be band-pass filtered (e.g., 0.01-50 Hz) using a band-pass filter 224, and processed by digital circuitry 230. The digital circuitry 230 can include analog-to-digital converters (ADC) 236 (with a 12-bit resolution, for example) that digitizes the filtered signals. To reduce the number of wires for high-density recordings, the power, clocks, and measured signals can be daisy-chained from one node to another with bit-serial outputs. That is, adjacent nodes (electrodes) can be connected together to (1) share the power, reference voltage, and ADC clocks, and (2) daisy chain the digital outputs.

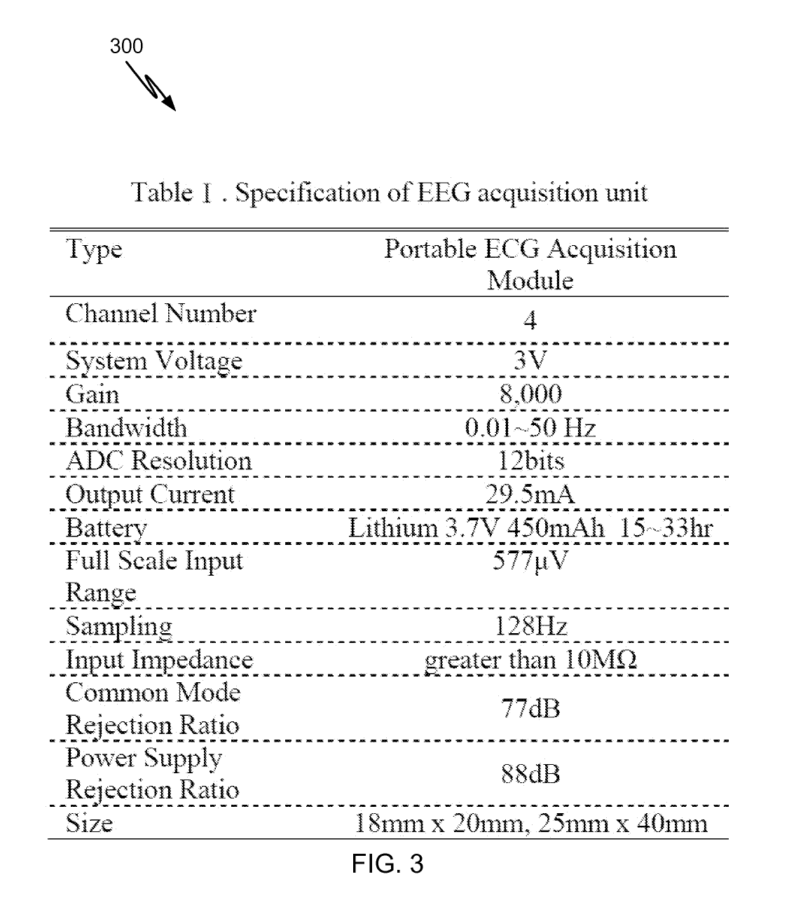

A microcontroller 234, such as TI MSP430 can be used as a controller to digitize EEG signals using ADC via serial peripheral interface with a sampling rate of 128 Hz, for example. The digitized EEG output signals 204 can be transmitted to a data receiver such as a cell phone via a communication transceiver, such as a Bluetooth module 232. An example of the communication transceiver can include Bluetooth module BM0203. In other implementations, different communication modules can be used, such as WiFi and infrared. The whole circuit can be integrated into a headband 250 as shown in FIG. 2B. Example specifications of the EEG acquisition unit 200 are listed in Table I 300 shown in FIG. 3.

In one embodiment, for testing the system, the data processing unit (e.g., mobile device) m realized using a Nokia N97 (Nokia Inc.) cell phone. A J2ME program developed in Borland JBuilder2005 and Wireless Development Kit 2.2 were installed to perform online procedures including (1) displaying EEG signals in time-domain or frequency-domain on the screen, (2) band-pass filtering, (3) estimating power spectrum of the VEP using fast Fourier transform (FFT), (4) presenting auditory feedback to the user, and (5) phone dialing. The resolution of the 3.5-in touch screen of the phone was 640×360 pixels.

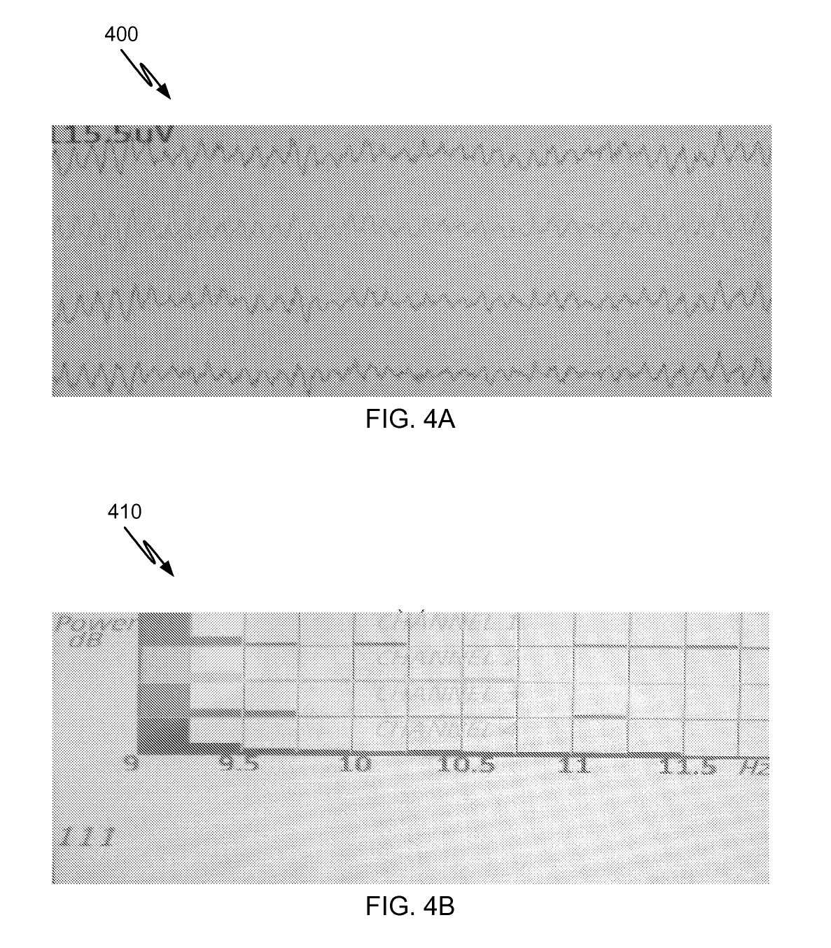

FIGS. 4A and 4B show screen snapshots of the cell-phone's GUI: (A) A time-domain display of the 4-channel EEG, and (B) Estimated power spectral density of the EEG when number ‘1’ was attended. Responsive to launching the software program on the data processing unit, a connection to the EEG acquisition unit can be automatically established in a few seconds. Once the connection is established, the EEG raw data are transferred from the EEG acquisition unit, plotted and updated periodically (e.g., every second) on the screen of the data processing unit. For the sampling rate of 128 Hz, the screen displays about 4-sec of data at any given time. FIG. 4A shows a snapshot 400 of the screen of the cell phone while plotting the raw EEG data in the time-domain. Users can switch the display mode from time-domain to frequency-domain by pressing one or more buttons on the data processing devices. For example, the user can press the “shift”+“0” button at the same time. FIG. 4B shows a screen shot 410 of the data processing device in the frequency-domain display mode. Under the frequency-domain display mode, the power spectral density of each channel can be plotted on the screen and updated periodically (e.g., every second), as shown in FIG. 4B.

Additionally, an auditory and visual feedback can be presented to the user once the dominant frequency of the SSVEP is detected by the program. For example, when the number ‘1’ is detected by the system, the digit ‘1’ can be shown at the bottom of the screen and an audible ‘ONE’ can be played at the same time.

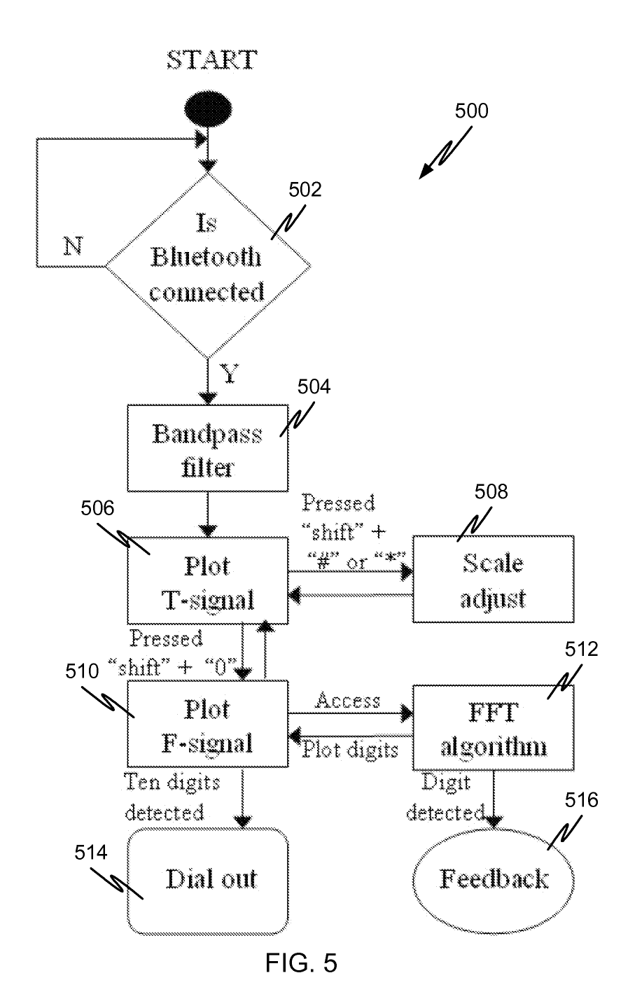

FIG. 5 shows an exemplary flow chart 500 of the software program coded on the data processing device, such as a cell phone. In the flow chart 500, the T-signal refers to the time-domain display, and F-signal refers to the frequency-domain display. In one aspect, the program initiates a connection to the EEG acquisition unit (502). Responsive to a successful connection, multi-channel (e.g., four-channel) raw EEG data are band-pass filtered (e.g., at 8-20 Hz) (504), and then plotted (506 and/or 510) on the screen periodically (e.g., every second). The display can be switched to the power spectrum display mode by pressing “shift”+“0” buttons simultaneously, as shown in FIGS. 4A and 4B. Additionally, a scale of the displayed data can be adjusted (508). A 512-point FFT can be applied to the EEG data using a 4-sec moving window advancing at 1-sec steps for each channel (512). To improve the reliability, a target is detected only when the same dominant frequency is detected in two consecutive windows (at time k, and k+1 seconds, k>4). The subjects are instructed to shift their gaze to the next target (digit) flashed on the screen of the stimulator once they are cued by the auditory feedback.

One example BCI experiment is now described. Ten volunteers with normal or corrected to normal vision participated in this experiment. The experiment was run in a typical office room. Subjects were seated in a comfortable chair at a distance of about 60 cm to the screen. Four electrodes on the EEG headband were placed around the O1/O2 area, all referred to a forehead midline electrode.

At the beginning of the experiment, each subject was asked to gaze at some specific digits to confirm the wireless connection between the EEG headband and the cell phone. Based on the power spectra of the EEG data, the channel with the highest signal-to-noise ratio was selected for online target detection. The test session began after a couple of short practice session. The task was to input a 10-digit phone number: 123 456 7890, followed by an ENTER key to dial the number. Incorrect key detection could be removed by a gaze shift to the “BACKSPACE” key. The percentage accuracy and ITR [1] were used to evaluate the performance of the cell-phone based BCI.

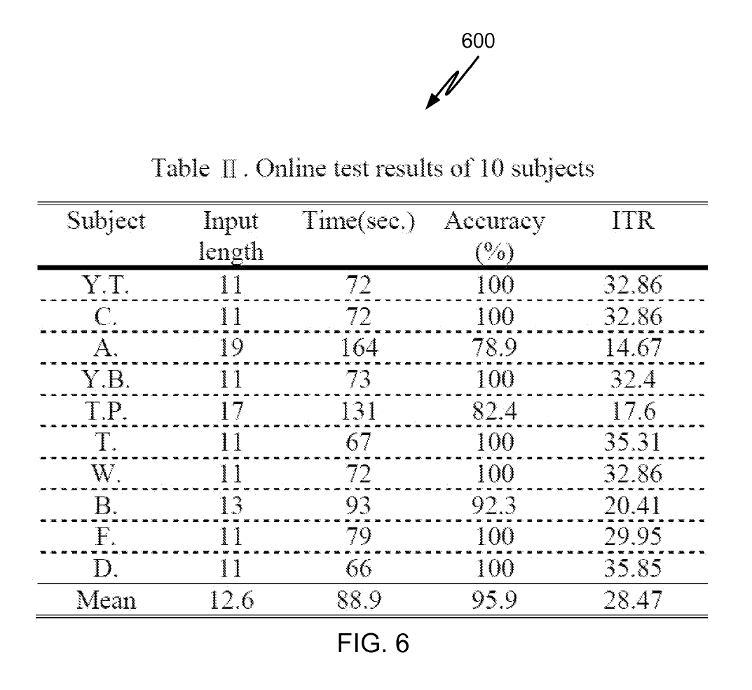

FIG. 6 shows Table II 600, which shows the results of the EEG-based phone-dialing experiments. All subjects completed the EEG-based phone-dialing task with an average accuracy of 95.9±7.4%, and an average time of 88.9 seconds. 7 subjects successfully inputted 11 targets without any error. The average ITR was 28.47±7.8 bits/min, which was comparable to other VEP BCIs implemented on a high-end personal computer.

Only a few embodiments are described of the design, development and testing of a truly mobile and wireless BCI for communication in daily life. A lightweight, battery-powered and wireless EEG headband can be used to acquire and transmit EEG data of unconstrained subjects in real-world environments. The acquired EEG data can be received by a regular cell phone through Bluetooth or any other wireless communication mechanism. Signal-processing algorithms and graphic-user interface can be developed and tested to make a phone call based on the SSVEPs in responses to frequency-encoded visual stimuli. Based in the test data collected, all of the participants, with no or little practicing, could make phone calls through this SSVEP-based BCI system in a natural environment.

Variations to the described embodiments can include: (1) the use of dry EEG electrodes over the scalp locations covered with hairs to avoid skin preparation and the use of conductive gels; and (2) the use of multi-channel EEG signals to enhance the accuracy and ITR of the BCI, as opposed to manually selecting a single channel from the recordings.

While the cell phone has been programmed to assess wearer's SSVEPs for making a phone call, and to function in ways appropriate for other BCI applications. In essence, this study is just a demonstration of a cell-phone based platform technology that can enable and/or facilitate numerous BCI applications in real-world environments.

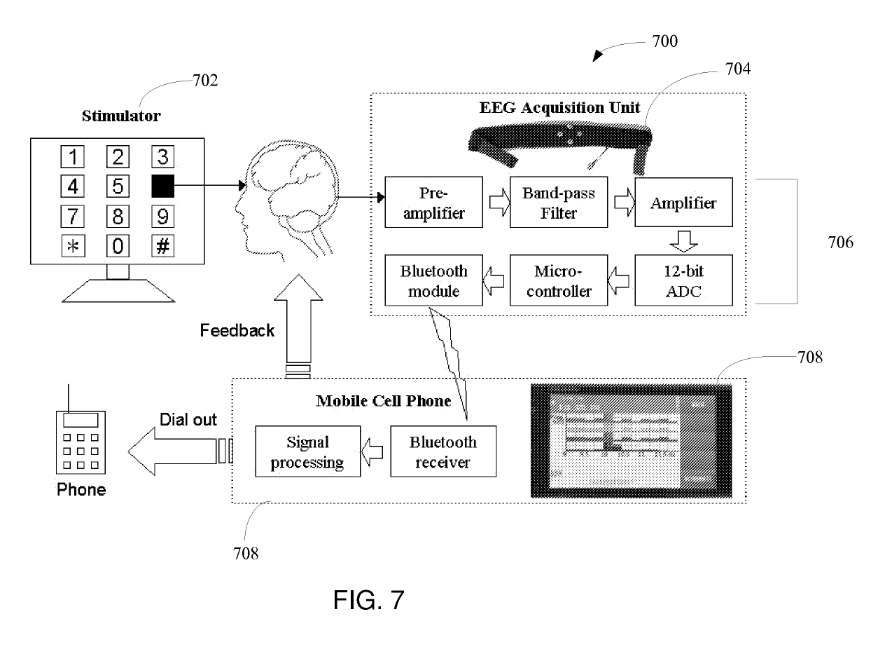

FIG. 7 represents another exemplary embodiment of a BCI system 700. A typical VEP-based BCI using frequency coding includes three parts: a visual stimulator 702, an EEG recording device 704 and a signal-processing unit 710. FIG. 7 depicts the basic scheme of the proposed mobile and wireless BCI system. The embodiment depicted in FIG. 7 adapts a mobile and wireless EEG headband 704 as the EEG recording device and a Bluetooth-enabled cell phone 710 as a signal-processing platform.

The visual stimulator 702 comprises a 21 inch CRT monitor (140 Hz refresh rate, 800×600 screen resolution) with a 4×3 stimulus matrix constituting a virtual telephone keypad which includes digits 0-9, BACKSPACE and ENTER. The stimulus frequencies ranged from 9 to 11.75 Hz with an interval of 0.25 Hz between two consecutive digits. In general, this cannot be implemented with a fixed rate of black/white flickering pattern due to a limited refresh rate of a LCD screen. In some embodiments, target frequencies of an SSVEP BCI may be approximated with variable black/white reversing intervals. For example, presentation of an 11 Hz target stimulus on a screen refreshed at 60 Hz can be realized with 11 cycle black/white alternating patterns lasting (3 3 3 2 3 3 3 2 3 3 2 3 3 3 2 3 3 3 2 3 3 2) frames in a second. Based on this approach, any stimulus frequency up to half of the refresh rate of the screen can be realized. The stimulus program was developed in Microsoft Visual C++ using the Microsoft DirectX 9.0 framework.

The EEG acquisition unit 704 is a four-channel, wearable bio-signal acquisition unit. EEG signals were amplified (8000×) by instrumentation amplifiers, band-pass filtered (0.01-50 Hz), and digitized by analog-to-digital converters (ADC) with a 12 bit resolution. To reduce the number of wires for high-density recordings, the power, clocks and measured signals were daisy-chained from one node to another with bit-serial outputs. That is, adjacent nodes (electrodes) are connected together to (1) share the power, reference voltage and ADC clocks and (2) daisy chain the digital outputs. Next, TI MSP430 was used as a controller to digitize EEG signals using ADC via serial peripheral interface with a sampling rate of 128 Hz. The digitized EEG signals were then transmitted to a data receiver such as a cell phone via a Bluetooth module. In this study, Bluetooth module BM0203 was used. The whole circuit was integrated into a light-weight headband.

The signal-processing unit 710 was realized using a Nokia N97 (Nokia Inc.) cell phone. A J2ME program developed in Borland JBuilder2005 and Wireless Development Kit 2.2 were installed to perform online procedures including (1) displaying EEG signals in time-domain, frequency-domain and CCA domain on the LCD screen of the cell phone, (2) band-pass filtering, (3) estimating the dominant frequencies of the VEP using FFT or CCA, (4) delivering auditory feedback to the user and (5) dialing a phone call. The resolution of the 3.5 inch touch screen of the phone is 640×360 pixels.

When the program is launched, the connection with the EEG acquisition unit is automatically established in just a few seconds. The EEG raw data are transferred, plotted and updated every second on the screen. Since the sampling rate is 128 Hz, the screen displays about 4 s of data at any given time. Users can choose the format of the display between time-domain and frequency-domain. Under the frequency domain display mode, the power spectral densities of the four-channel EEG will be plotted on the screen and updated every second. An auditory and visual feedback is presented to the user once the dominant frequency of the SSVEP is detected by the program. For example, when number 1 is detected by the system, the digit ‘1’ is shown at the bottom of the screen and ‘ONE’ would be said at the same time.

Software operation and user interface include several functions. First, the program initiates a connection with the EEG acquisition unit. Second, four channels of raw EEG data are band-pass filtered at 8-20 Hz, and then plotted on the screen every second. Third, the display can be switched to the power spectrum display or time-domain display by pressing a button at any time. FIG. 7 includes a screen shot 708 of the cell phone, which plots the EEG power across frequency bins of interest. Fourth, an FFT or CCA mode can be selected. In the FFT mode, a 512 point FFT is applied to the EEG data using a 4 s moving window advancing at 1 s steps for each channel.

In the CCA mode, it uses all four channels of the EEG with a 2 s moving window advancing at 1 s steps continuously. The maximum window length is 8 s. To improve the reliability, a target is detected only when the same dominant frequency is detected in two consecutive windows (at time k and k+1 s, k _{—}4 in the FFT mode, and _{—}2 in the CCA mode). The subjects were instructed to shift their gaze to the next target once they heard the auditory feedback.

As previously discussed, ten volunteers with normal or corrected to normal vision participated in this experiment. All participants were asked to read and sign an informed consent form before participating in the study. The experiments were conducted in a typical office room without any electromagnetic shielding. Subjects were seated in a comfortable chair at a distance of about 60 cm from the screen. Four electrodes on the EEG headband were placed 2 cm apart, surrounding a midline occipital (Oz) site, all referred to a forehead midline electrode (one embodiment of the sensor array is shown in FIG. 1).

The FFT- and CCA-based approaches were tested separately. All subjects participated in the experiments during which the cell phone used FFT to detect frequencies of SSVEPs, and four subjects were selected to do a comparison study between using FFT and CCA for SSVEP detection. At the beginning of the experiment, each subject was asked to gaze at some specific digits to confirm the wireless connection between the EEG headband and the cell phone. In the FFT mode, the channel with the highest signal-to-noise ratio, which is based on the power spectra of the EEG data, was selected for online target (digit) detection.

Four of ten subjects who showed better performance (i.e. a higher ITR in the FFT mode) were selected to further test the CCA-based SSVEP BCI. The test session began after a couple of short practice sessions. The task was to input a ten digit phone number, 123 456 7890, followed by the ENTER key to dial the number. Incorrect key detection could be erased by using the BACKSPACE key. In the CCA mode, the same task was repeated six times, leading to 11×6 selections for each subject. The EEGs in the CCA experiments were saved with feedback codes for an offline comparison study between FFT and CCA. The percentage accuracy and ITR [1] were used to evaluate the BCI performance.

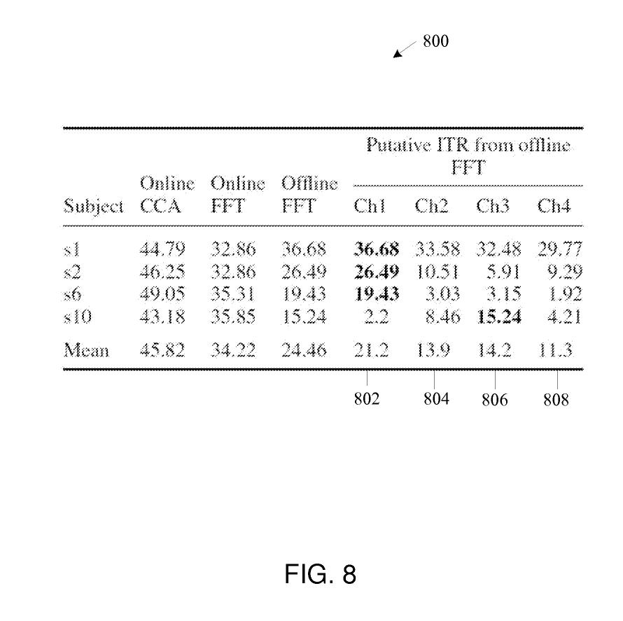

FIG. 8 depicts Table 800 showing results of the SSVEP BCI using CCA for the four subjects. In the FFT mode, all subjects completed the phone-dialing task with an average accuracy of 95.9±7.4% and an average time of 88.9 s. Seven of ten subjects successfully inputted 11 targets without any errors. The average ITR was 28.47±7.8 bits min−1, which was comparable to other VEP BCIs implemented on a high-end personal computer. Table 800 shows the results of the SSVEP BCI using online CCA on the cell phone. CCA achieved an averaged ITR of 45.82±2.49 bits/min, which is higher than that of the FFT-based online BCI of the four participants (34.22 bits/min). Applying FFT to the EEG data recorded during the experiments using the online CCA resulted in an averaged putative ITR of 24.46 bits/min, using the channel with the highest accuracy for each subject, as shown in columns 802, 804, 806 and 808 of Table 800.

It will be appreciated that a portable, cost effective and miniature cell-phone-based online BCI platform for communication in daily life is possible using the disclosed embodiments. A mobile, lightweight, wireless and battery-powered EEG headband may be used to acquire and transmit EEG data of unconstrained subjects in real-world environments. The acquired EEG data may be received by a regular cell phone through Bluetooth. Advances in mobile phone technology have allowed phones to become a convenient platform for real-time processing of the EEG. In one aspect, the cell-phone-based platform propels the mobility, convenience and usability of online BCIs.

The practicality and implications of the proposed BCI platform through the high accuracy and ITR of an online SSVEP-based BCI, will be appreciated by one of skill in the art. To explore the capacity of the cell-phone platform, two experiments were carried out using an online single-channel FFT and a multi-channel CCA algorithm. The mean ITR of the CCA mode was higher than that of the FFT approach (−45 bit/min versus 34 bits/min) in the four participants. An offline analysis, which applied FFT to the EEG data recorded during the online CCA-based BCI experiments, showed that the target selection was less accurate using FFT than CCA, which in turn resulted in a lower ITR (Table 800). The decline in accuracy and ITR in offline FFT analysis could be attributed to a lack of sufficient data for FFT to obtain accurate results. In other words, FFT, in general, required more data (longer window) than CCA to accurately estimate the dominant frequencies in SSVEPs (6 s versus 4 s). Further, the multi-channel CCA approach eliminated the need for manually selecting the ‘best’ channel prior to FFT analysis.

In system 700, the cell phone 710 may be programmed to assess the wearer's SSVEPs for making a phone call, but it can actually be programmed to realize other BCI applications. For example, the current system can be easily converted to realize a motor imagery-based BCI by detecting EEG power perturbation of mu/beta rhythms over the sensorimotor areas. In essence, this study is just a demonstration of a cell-phone based platform technology that can enable and/or facilitate numerous BCI applications in real-world environments.

Various useful and tangible applications are possible. For example, the BCI system can be used for single- or multiple-player gaming on cell phones. Additionally, the BCI system as described can be used for biomedical information monitoring and abnormality warning system in clinical research and practice in neurology, psychiatry, gerontology, and rehabilitation medicine. Cell phones can continuously monitor the users' physiological data and detect abnormality online and transfer the information through cell-phone network to a healthcare server which can alert healthcare providers about the patient's physical, mental or even cognitive status as well as their geometrical locations from any time, any place and anywhere. Examples of status include alertness level, attention, intents, frustrations, confusion and emotional states such as happy, sand, angry, etc.

Dry and non-contact electroencephalographic (EEG) electrodes, which do not require gel or even direct scalp coupling, have been considered as an enabler of practical, real-world, brain-computer interface (BCI) platforms. This study presents a in-depth study directly comparing wet electrodes to dry and through hair non-contact electrodes within a Steady State Visual Evoked Potential (SSVEP) BCI paradigm. The construction of a dry contact electrode, featuring fingered contact posts and active buffering circuitry is presented. Additionally, the development of a new, non-contact, capacitive electrode that utilizes a custom integrated, high-impedance analog front-end is introduced. Offline tests on 10 subjects characterize the signal quality from the different electrodes and demonstrate successful acquisition of small amplitude, SSVEP signals is possible, even through hair using the new integrated non-contact sensor. Online BCI experiments demonstrate that ITR rates with the dry electrode are comparable to that of wet electrodes, completely without the need for gel or other conductive media. In addition, data from the non-contact electrode, operating on the top of hair, show maximum ITR rates in excess of 20 bits/min at 100% accuracy (versus 29.2 bits/min for wet electrodes and 34.4 bits/min for dry electrodes), a level that has never been demonstrated before. The results of these experiments show that both dry and non-contact electrodes, with further development may become a viable tool for both future mobile BCI and general EEG applications.

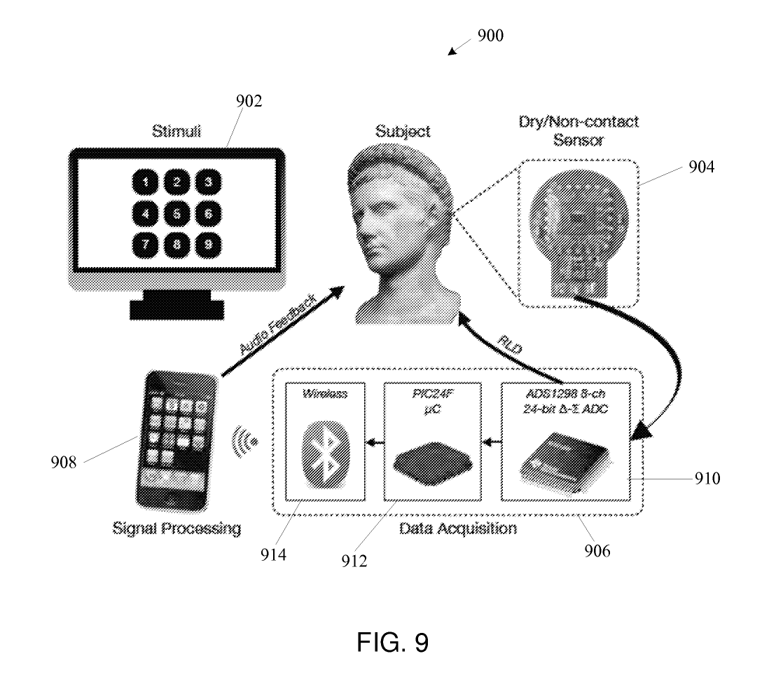

With aim to advance the use of dry and non-contact electrodes specifically for BCI, certain embodiments are disclosed in this specification. In some embodiments, an active electrode may be built from standard off-the-shelf electronic components. Spring loaded fingers may be used to provide for electrical connection to the scalp by pushing through the strands of hair. High contact impedances from the absence of gel and the small contact surface may be mitigated with the use of an onboard buffer. In some embodiments, high impedance, non-contact electrodes, based on a custom integrated analog front-end, may be used. Non-contact electrodes have been explored for ECG use and more rarely, EEG as well. FIG. 9 depicts an example BCI system 900 that utilizes a dry or non-contact sensor. The BCI system 900 comprises a visual stimulator 902, and a subject wearing a dry/ non-contact sensor 904. The data acquisition subsystem 906 may include analog-to-digital conversion unit 910, a microprocessor 912 and a transceiver 914. The signal processing unit may comprise a smartphone or a tablet 908.

The signal quality requirements may typically be far more stringent for EEG than ECG, and conventional sensors are limited by noise and usability issues. In contrast, the fully custom sensor front-end embodiments disclosed in this specification are able to bypass many of the input impedance, noise and biasing issues encountered thus far.

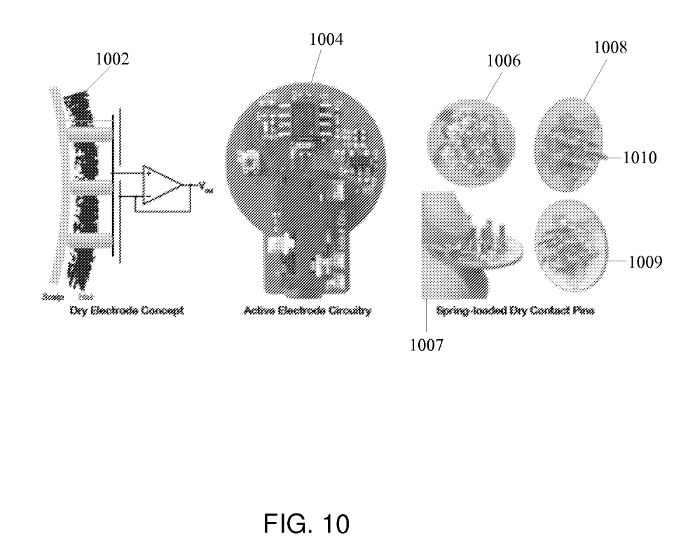

FIG. 10 is a block diagram representation of a dry electrode (sensor). As depicted in 1002, a dry electrode may be positioned in close proximity of a subject, e.g., near scalp/hair of the subject. The dry sensor may include a small circuit board 1004, comprising active electrode circuitry.

The dry sensor embodiment 1007 includes two sections. A lower (or base) plate 1006 contains a set of spring-loaded pin contacts mounted on the base plate 1006 which can easily penetrate hair without the need for any preparation. The gold plated fingers 1010 achieve direct electrical connection to the scalp (other durable and conductive metals may also be used). A snap connector (e.g., of male type, identical to the one used for ECG electrodes) on the top side of the plate mates with a counterpart (e.g., female type connector) on a second PCB which contains the active electrode circuitry. Left and right side views 1008 and 1009 of the lower plate 1006 show the fingers 1010 standing out from the lower plate 1006.

Relatively high impedance signals offered by the dry contact are buffered with an off-the-shelf CMOS-input op-amp (e.g., National Semiconductor LMP7702). The unity gain buffer, along with the shielded cabling, greatly reduces the effects of external interference.

The signal quality from this very simple dry electrode may be excellent, and may not require additional calibration or preparation. Compared to the wet electrode, a greater amount of low-frequency drift may be observed in some embodiments, likely due the high contact impedance and the less stable electrochemical interface of the Au pins versus the normal Ag/AgCl electrode. Nevertheless, these effects may be easily removed and far below SSVEP frequencies of interest, as further discussed below. No discomfort was reported by the users during usage. The fingers 1010 increase the potential of an injury hazard in cases of direct head trauma. The non-contact sensors described below alleviate such a problem.

As previously mentioned, non-contact electrodes which operate primarily via capacitive coupling have been studied for various applications, including EEG. Although dry scalp based electrodes are still relatively easy to handle with active electrode technology, the extremely high contact impedance (>10 Giga Ohms, 30 pF capacitance), in the same order of magnitude as even the best CMOS-input amplifiers, of through-hair coupling has a significant challenge in acquiring acceptable EEG signals. The attenuation due to source-input impedance division significantly degrades common mode rejection ratio (CMRR) of the front-end amplifiers. In addition, the high impedance interface can also, in many cases, generate significant amounts of intrinsic noise and is susceptible to various movement artifacts and microphonics.

High input impedance through careful design and control of the sensitive input node, made possible by a custom VLSI circuit implementation. Previous attempts at building non-contact sensors have always relied on active shielding to minimize noise and interference, but the shield's effectiveness was necessarily constrained to just the PCB-level due to the lack of access to the internal nodes of the off-the-shelf amplifiers used in the front-end. Any parasitic capacitances internal to the amplifier (˜2-20 pF) still had to be eliminated via manually tuned neutralization networks. Not only is this calibration process imperfect, it also precludes the mass production of these sensors. In contrast, the disclosed embodiments fully bootstrap and shield the input node, starting from the active transistor, extending out to the bondpads and out to a specially constructed chip package. The ability to fully shield the input node eliminates the need for carefully tuned input capacitance neutralization, as with other designs and achieves an input capacitance of just 60 fF. Moreover, the integrated approach may make it possible to implement low-leakage, low-noise (0.5 fA/Hz^{1/2}) bias structures that simultaneously enable fast input overload recovery and stable low frequency response (<0.05 Hz).

Testing of the integrated non-contact sensor demonstrated significant performance improvements compared to conventional non-contact electrodes built with discrete components. Direct comparison against older non-contact sensors, even with careful neutralization, showed that the new integrated sensor achieved a much closer signal correlation (r=0.953 versus r=0.918 and r=0.715) to the signals obtained with clinical wet Ag/AgCl electrodes. Although the signal quality of this integrated non-contact sensor is still noisier and less robust than the dry and wet contact electrodes, integrated non-contact sensor embodiments can acquire SSVEP signals at much finer gradations than was possible before.

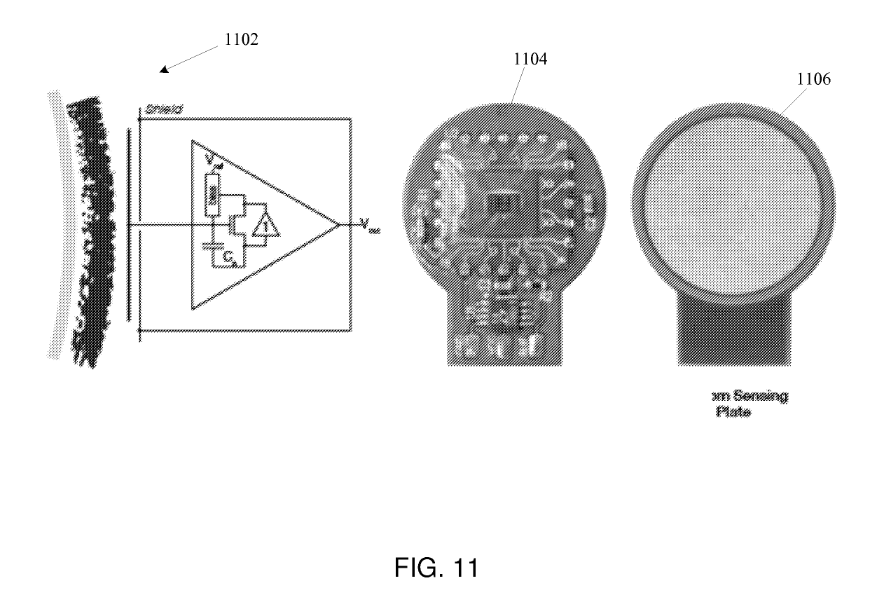

FIG. 11 is a block diagram representation of a non-contact sensor embodiment. A set of standard passive hydrogel ECG electrodes were used as a control in the experiments. The adhesive sections of the electrodes were removed, leaving only the hydrogel which was placed on top of the subject's hair (see, 1102). Additional conductive gel was dispensed to ensure a good electrical connection to the scalp. No special preparation of the skin, such as abrasion, was required. The low-impedance of the wet electrode, even without any active buffering circuitry, exhibited the best signal quality in terms of noise and drift. Element 1106 shows the sensing plate of the non-contact sensor (electrode).

Each of the sensors is connected directly to an octal, simultaneous sampling 24-bit delta-sigma ADCs (e.g., TI ADS1298). The ADC is controlled by a PIC24F low-power microcontroller which acquires samples and dispatches the data to an onboard Bluetooth module (1104). The portable data acquisition box is powered by two AAA batteries, good for approximately 10 hours of continuous wireless telemetry.

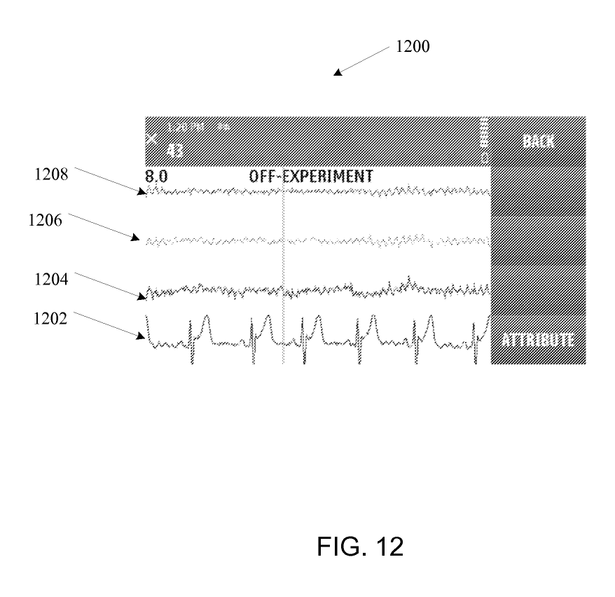

Signal processing of the EEG telemetry was accomplished on a Nokia N97 cellular phone. A sample plot of alpha wave activity, displayed on the phone's 640×360 pixel 3.5 in touchscreen LCD, from 3 non-contact electrodes is shown in FIG. 12.

FIG. 12 shows a graph 1200 in which sample data (0 to 50 Hz bandwidth) from three non-contact electrodes, over hair, transmitted on display on a cell phone is shown (curves 1204, 1206, 1208). A reference ECG signal 1202, taken with a standard wet electrode on the chest, is also displayed.

The BCI application was written in J2ME (Java 2 Micro Edition) using JBuilder 2005. The phone establishes a Bluetooth serial port connection with the data acquisition box and initially presents the user with raw telemetry. After the EEG signal quality has been verified by the user, the application can switch to canonical correlation analysis (CCA) mode for actual BCI experimentation. In the analysis mode, a band-pass filter is applied to the signal to remove frequencies that are outside the SSVEP band (9-12 Hz).

The CCA analysis algorithm attempts to obtain the maximum correlation between signals from the three recording electrodes with a matrix of sine/cosine templates that correspond to the 12 possible stimulus frequencies. For the experiments involving wet and dry electrodes, decisions are made on a four second sliding window that advances in one second increments. Two consecutive decisions are construed as a successful input and trigger an audio feedback to notify the subject. To allow for the subject time for rest and blinks, a one second blackout is enforced after each input. During the tests, it was found that the 4 s window, 2 consecutive decisions was not reliable for the non-contact electrodes due to degraded SNR. Increasing the window to 6 s with four consecutive decisions allowed for sufficient rejection of the extra noise.

To first validate the signal being acquired by the dry and non-contact sensors compared to the standard wet Ag/AgCl electrode, a comparative experiment was devised and performed on ten different subjects. The experiment consisted of having each subject gaze at a single SSVEP target stimulus, displayed on a CRT monitor, at 10 Hz for a one-minute duration. During the experiment, the SSVEP signal was decoded, in real-time, to verify the presence of the 10 Hz stimulus signal, but no feedback was presented to the subject. Each subject repeated this task three times, and the best dataset was used for analysis. None of the subjects had shaved heads and in all cases, the non-contact sensor was on top of several layers of hair.

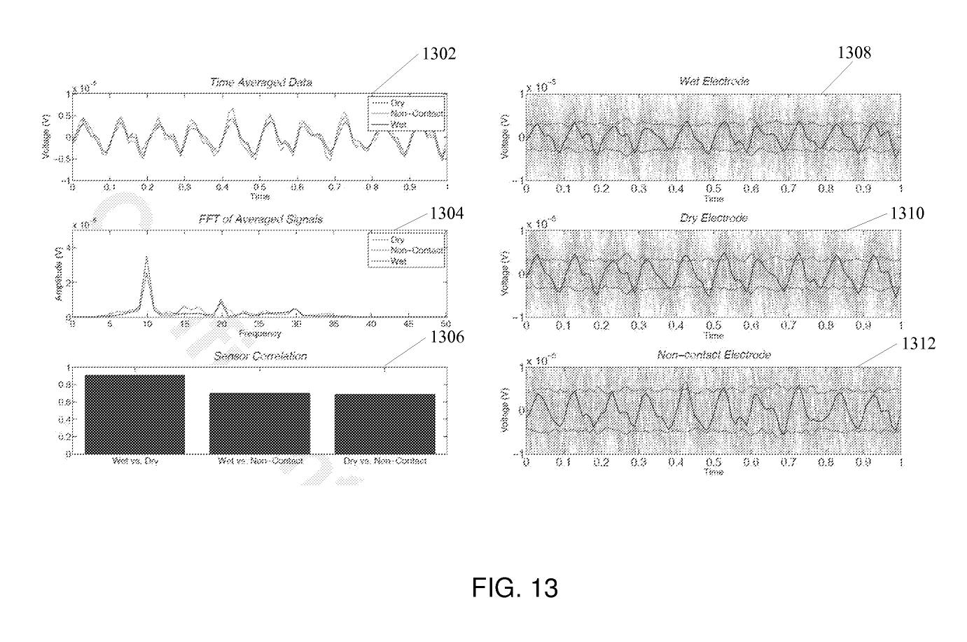

Directly benchmarking several EEG sensors on a live subject can be problematic. Unlike ECG where there exists large areas at an equipotential (e.g. limbs), closely spaced EEG electrodes can observe different signals. In this experiment the three sensors (wet, dry and non-contact), were arrayed in a triad over the occipital region as closely together as possible. The relative placement of the electrodes was consistent between different subjects. Care was taken to prevent gel from the wet electrode seep into the neighboring dry and non-contact electrodes. A sample plot of the raw and time averaged SSVEP signal for one subject is shown in FIG. 13.

FIG. 13 shows graphical representation of sample time averaged SSVEP signals from wet, dry and non-contact electrodes (graph 1302) from a subject during a 6 second trial. The corresponding FFTs are shown in graph 1304. Graph 1306 shows the correlation between sensor pairs compared with each other. Averaging was performed over a 1 second period using a 0.5 second sliding window. Details signals from each electrode, the corresponding averages and standard deviations are shown in graphs 1308, 1310 and 1312.

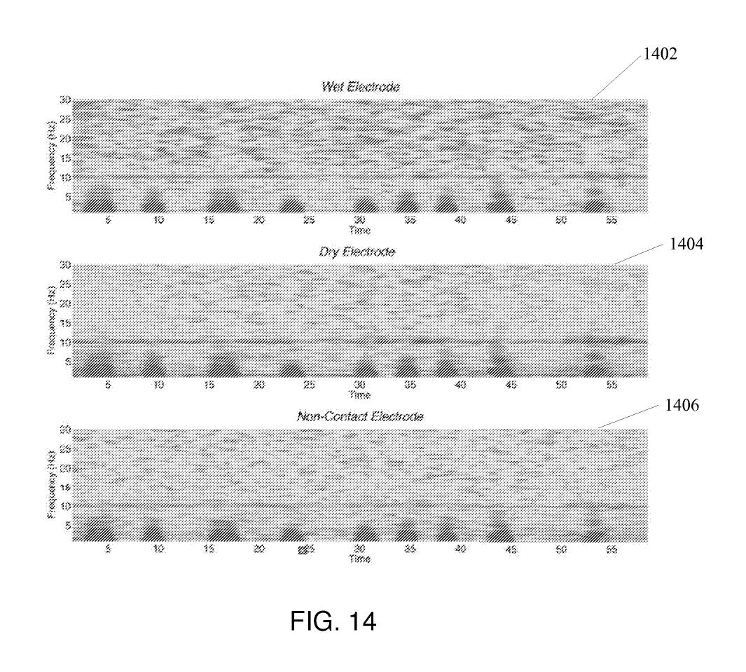

FIG. 14 shows spectrograms for a 60 second trial for another subject, using dry, wet and non-contact electrodes (1404, 1402 and 1406 respectively). The 10 Hz SSVEP stimulus is visible in each spectral plot. Blink artifacts are also visible.

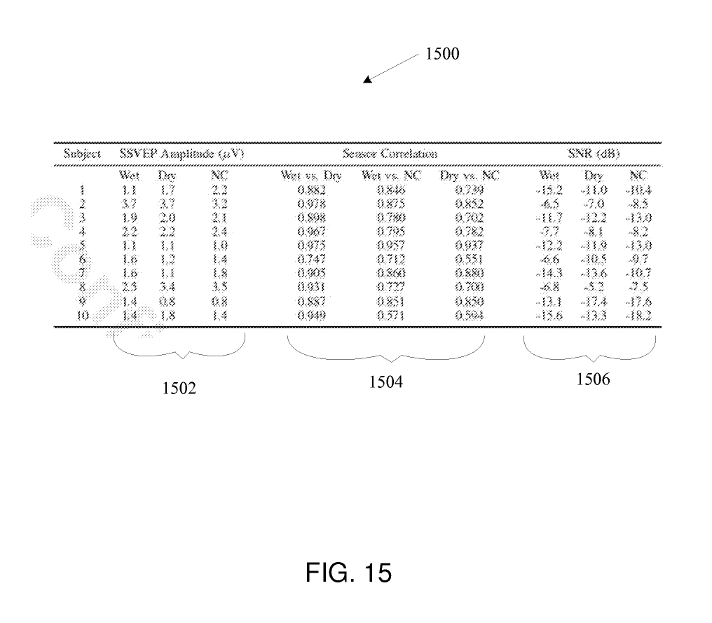

FIG. 15 shows table 1500, tabulating results in ten subjects, of SSVEP amplitudes (1502), sensor correlations (1504) and SNR (1506) for wet, dry and non-contact (NC) sensors.

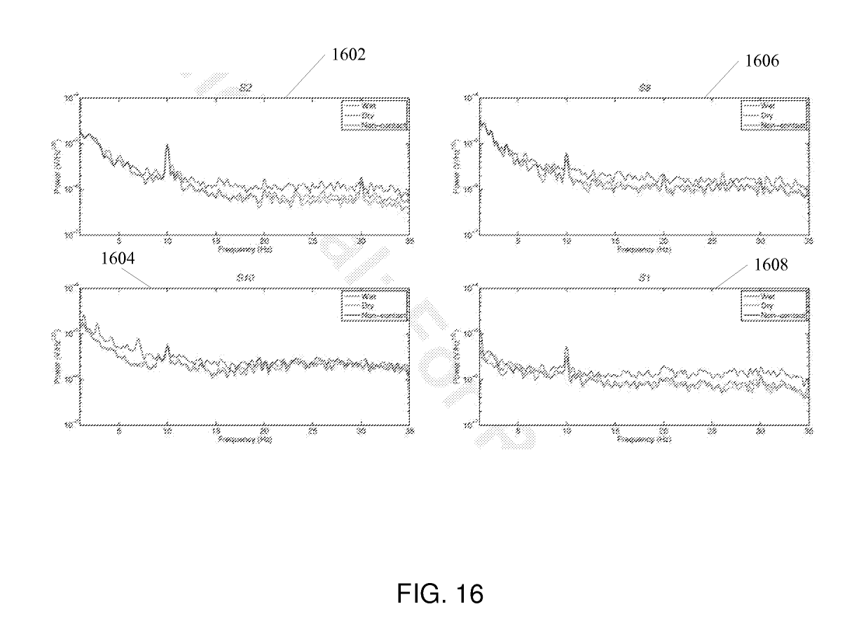

FIG. 16 is a graphical representation of power spectral densities (PSDs) for four different subjects (graphs 1602, 1604, 1606 and 1608), during an experiment in which EEG signals were acquired using wet, dry and non-contact sensors for each subject. The amplitude of the SSVEP and amount of the background ‘noise’ varies considerably between subjects. From first glance, the PSD from the wet electrode almost perfectly matches that from the dry electrode, consistent from our observations that aside from larger amounts of drift, the signal quality from the dry electrode was excellent. The PSD of the non-contact electrode's signal also clearly shows the 10 Hz stimulus, verifying that it is indeed capable of acquiring EEG signals through hair. Unlike the dry electrode, the non-contact sensor can exhibit a greater amount of both low-frequency drift as well as broadband noise due to the extremely high coupling impedance and sensitivity to movement artifacts. In one subject (graph 1604) a pulse artifact can be seen in the spectra due to poor coupling of the non-contact electrode.

For quantitative analysis of the signal quality from the various electrode types, a few key parameters are desired. First, it is useful to obtain a metric that conveys how close the signal from dry and non-contact electrodes matches the signal from a ‘gold standard’ wet electrode. Secondly, it is also useful to know the ratio, or SNR, provided by each electrode showing the amount of useful signal, in this case SSVEP, versus the background noise.

Specifically for this experiment, the signals obtained from the three sensors were first band-pass filtered around 8-13 Hz to remove all frequencies not relevant to the SSVEP stimulus. Since the SSVEP signal is small, this removes the majority of noise in the signal and enables a correlation comparison between the three sensors specifically for the SSVEP. To account for phase shifts of the SSVEP signal due to differences in electrode placement, the cross correlation (MATLAB xcorr) was used, and the maximum value was extracted for three comparisons: wet vs. dry, wet vs. non-contact and dry vs. non-contact. A summary of the computed correlations can be found in Table I.

For the dry electrode, over half the subjects had a correlation of greater than 0.9 between the wet and dry electrodes, with three subjects achieving almost perfect correlation (0.978, 0.967, 0.975). Only one subject exhibited a wet vs. dry electrode correlation of less than 0.8. Correlation values of the wet versus non-contact electrode were lower, which was not surprising. Nevertheless, half the subjects had correlation values of above 0.8. Only one subject had a correlation value of 0.7.

Previous studies of dry electrodes typically found correlation values of approximately 0.8 between neighboring wet and dry electrodes for large signal bandwidths. However, the experiments disclosed here are narrow band in nature (8-13 Hz). This difference in bandwidth makes a direct, objective comparison difficult. As an example, decreasing the high pass corner from 8 Hz to 0.5 Hz, would introduce drift noise, which typically has large amplitude, into the correlation comparison. If the two electrodes were drifting independently, then the correlation value would decrease towards zero. On the other hand, if the common reference electrode was in poor contact and noisy, causing the two recording electrodes to drift synchronously, then the correlation value will increase towards one. Either process would likely dominate the low amplitude SSVEP signal. Thus for the experiments in this study, which focuses on the SSVEP paradigm, a narrowband approach that filters out only the signals of interest is justified.

The second metric, SNR, was computed by examining the root-mean square amplitude of the fundamental 10 Hz tone, obtained via an FFT on the time averaged data (\tilde{x}), versus the background noise within the 8-13 Hz SSVEP band,

$$SNR = 10 {log}_{10} \frac{{\overline{X} ( 10 Hz )}_{rms}^{2}}{var ( x ) - {\overline{X} ( 10 Hz )}_{rms}^{2}} . \qquad ( 1 )$$

The background noise was approximated by subtracting out the contribution from the SSVEP tone from the standard deviation of the 8-13 Hz band-passed EEG (x) signal during the 60 s trial. This allows for a direct comparison of the signal strength versus noise for each electrode. This number, provided in Table I, represents the instantaneous SNR and is always well below 0 dB due to the small amplitude of the SSVEP signal relative to the background EEG and noise. Reliable detection of the stimulus, however, is made possible by the processing gain from FFT or CCA analysis of the signal over a time window.

Offline analysis of benchmark data shows that SSVEP signals can be reliably extracted from dry and even non-contact electrodes. To demonstrate their use in real-time BCI applications, subjects 1, 2 and 4 were recalled to perform a SSVEP phone dialing task using the mobile signal processing platform as previously described.

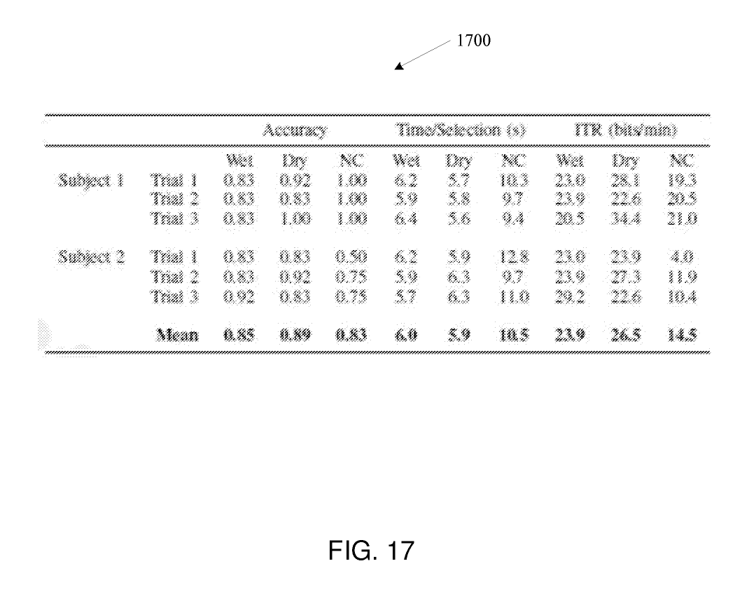

The online task consisted of entering a predetermined 12-digit sequence. The time to complete the task along with the error rate was recorded and used to calculate the ITR. Signal decoding was performed using CCA analysis on data streamed across the wireless link. A full suite of tests was conducted on subjects 1 and 2 which consisted of using all three of the electrode types in multiple separate trials. Data from the tests is shown in Table 1700, depicted in FIG. 17.

Both subjects were able to achieve control of the BCI system using any electrode type. As expected, the wet and dry electrodes were could both be successfully used for BCI, although with a minor error rate, typically 1 or 2 errors out of 12. Although the ITR rates in this experiment do not quite match the best of previous reports in the literature, it does provide for a baseline in this comparative study. It is possible that higher ITR rates could be achieved if more electrodes were available—in the current experiment; only three electrodes are used at a time. It is interesting to note that the dry electrode trials actually achieved superior performance to the wet electrode trials. This is likely attributed to the fact that the wet electrode was always tested last (to avoid gel contamination on the dry and non-contact sensors). Subject fatigue and variability may have a significant performance impact over time.

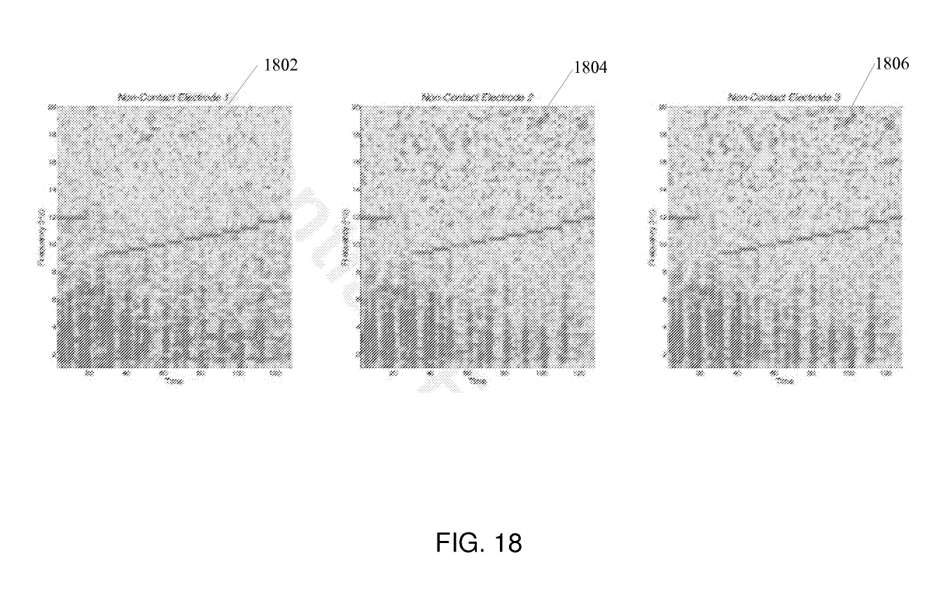

FIG. 18 shows spectrograms of data taken during a real-time SSVEP decoding task using three different non-contact electrodes (1802, 1804 and 1806). The SSVEP sweep across different frequencies may be seen in all graphs. The data was taken over a 6 second sliding window.

With the non-contact electrodes, one of the subjects (1) was able to consistently achieve 100%. Although a longer detection window was required to compensate for the increased noise with non-contact electrodes, we were able to achieve an ITR rate of over 20 bits/min. To our knowledge, this level of performance with non-contact electrodes has never been demonstrated before. The only previous study of true non-contact, capacitive BCI achieved an ITR of 12.5 bits/min, which required both a training session and the use of significantly less selection choices (3 vs. the 12 in the present specification). This strong indicator that not only do the new integrated non-contact electrodes do indeed acquire useful EEG, the signal quality is of sufficient quality for BCI.

Subject 2 (see Table 1700) had more difficulty with utilizing the non-contact electrodes, probably a result of thicker hair which increased the probably decreased the SNR and made the sensors more susceptible to motion artifacts. Movement induced errors were a challenge in subject 2's trial since the SSVEP paradigm requires a stable signal over a time window (4 to 6 s). Transient artifacts appear as a large 1/f disturbance in the frequency domain and can cause either decoding errors and/or excessively long decision times.

An interesting dichotomy was noted during the experiments. Whereas wet electrodes typically perform well shortly after application (allowing for a short time to stabilize the electrochemical interface), the dry and non-contact electrodes take much longer to achieve a stable trace. On the other hand, wet electrodes are susceptible to drying of the electrogel over time, but the signals from dry and non-contact electrodes do not degrade with time. This is likely due to sweat and other effects moisturizing the hair and skin under the electrode, achieving improved coupling. While this phenomenon with dry and non-contact electrodes is disadvantageous in time constrained laboratory applications, it may be useful for long-term mobile use.

It will be appreciated that the disclosed dry and non-contact electrodes meet the need for sensor arrays that do not require time and labor intensive preparation to truly transition laboratory innovations into general practice. In one aspect, the disclosed electrode embodiments overcome the usability shortcomings inherent with wet Ag/AgCl electrodes. Quantitative benchmarking shows that dry and non-contact electrodes are fully capable of resolving SSVEP signals. In many cases, the dry electrode only shows a slight amount of signal degradation, except for increased drift, compared to the standard wet Ag/AgCl electrode. The non-contact electrode, through hair, shows somewhat more degradation, but the signal quality still remains useful. The online experiments in this study demonstrate that both electrodes are feasible for BCI applications.

In general, movement artifacts and electrode placement remain an unresolved challenge with both dry electrodes and especially non-contact electrodes. For the purposes of this study, we utilized a simple, tight, elastic band around the subject's head. The sensors were tucked underneath the band during experimentation. It will be appreciated that signal processing algorithms for artifact rejection in conjunction with the electrode technologies presented here and further characterization may be used to significantly advance the field of mobile BCI systems.

It will be appreciated that, in one aspect, an electrode for use in a brain computer interface application is disclosed. The electrode comprises a base plate, a plurality of spring-loaded pin contacts mounted on the base plate, and a snap connector on a top side of the base plate. The snap connector is configured to couple to an external circuit. The plurality of spring-loaded pin contacts is configured to make a dry contact with a subject to sense electroencephalographic signals from the subject.

Implementations of the subject matter and the functional operations described in this specification can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a non-transitory machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices. The processor and the memory can be supplemented by, or incorporated in, special purpose logic circuitry.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is:

1. A system for implementing a brain-computer interface, the system comprising:
a stimulator to provide at least one stimulus to a user to elicit at least one electroencephalogram (EEG) signal from the user;
an EEG acquisition unit in communication with the user to receive and record the at least one EEG signal elicited from the user; and
a data processing unit in wireless communication with the EEG acquisition unit to receive and process the recorded at least one EEG signal to perform at least one of:
sending a feedback signal to the user, and
executing an operation on the data processing unit.

2. The system of claim 1, wherein the EEG acquisition unit comprises:
at least an electrode in communication with the user to receive the EEG signal;
analog circuitry to amplify and filter the received EEG signal; and
digital circuitry to generated a digital EEG signal based on the amplified and filtered EEG signal.

3. The system of claim 2, wherein the analog circuitry comprises:
instrument amplifiers to amplify the received EEG signal; and
a filter to band-pass filter the amplified EEG signal.

4. The system of claim 3, wherein the digital circuitry comprises:
an analog-to-digital converter to generate digital EEG signals based on the amplified and filtered EEG signal; and
a microcontroller in communication with the analog-to-digital converter to control generation of the digital EEG signal.

5. The system of claim 1, wherein the data processing unit is configured to:
receive the digital EEG signal from the EEG acquisition unit;
process the received digital EEG signal; and
responsive to processing the received digital EEG signal, perform the at least one of sending a feedback signal to the user or executing a function on the data processing device.

6. The system of claim 1, wherein the data processing unit comprises a mobile cellular phone.

7. The system of claim 1, wherein the stimulator unit comprises a visual stimulator to provide at least one visual stimulus to the user.

8. The system of claim 7, wherein the visual simulator comprises:
a monitor with a stimulus matrix.

9. The system of claim 1, further comprising a stimulus program for causing the stimulator to apply the at least one stimulus to the user.

10. The system of claim 9, wherein the stimulus program is configured to vary frequencies of the applied at least one stimulus.

11. The system of claim 1, wherein the EEG acquisition unit further comprises a communication transceiver to transmit the digitized EEG signal to the data processing device.

12. The system of claim 11, wherein the communication transceiver comprises a Bluetooth transmitter.

13. The system of claim 11, wherein the data processing unit comprises a communication transceiver to receive the transmitted digital EEG signal.

14. The system of claim 1, wherein the data processing unit is configured to make a telephone call.

15. A method of implementing a brain-computer interface, the method comprising:
initiating a connection between a data processing device and an electroencephalogram EEG acquisition unit; and
responsive to a successful connection,
receiving raw EEG data,
band-pass filtering the received raw EEG data, and
plotting the filtered EEG data on a screen.

16. The method of claim 15, comprising:
responsive to a user input, switching a display mode of the plotted EEG data between a time-domain display mode and a frequency-domain display mode.

17. The method of claim 15, adjusting a scale of the plotted data.

18. The method of claim 15, applying a fast Fourier transform, FFT, algorithm to the filtered EEG data using a moving window.

19. The method of claim 18, further comprising detecting a target responsive to detecting a same dominant frequency in two consecutive windows.

20. A computer storage medium embodying instructions configured to cause a data processing device to perform operations comprising:
initiating a connection between the data processing device and an EEG acquisition unit; and
responsive to a successful connection,
receiving multi-channel raw EEG data,
band-pass filtering the received raw EEG data, and
plotting the filtered EEG data on a screen of the data processing device periodically.
